(19) United States
(12) Patent Application Publication
(10) Pub. No.: US 2016/0148248 A1
(43) Pub. Date: May 26, 2016

(54) Multi-Channel Marketing Campaigns

(71) Applicant: Adobe Systems Incorporated, San Jose, CA (US)

(72) Inventors: Ritwik Sinha, Kolkata (IN); Sanket Vaibhav Mehta, Maharashtra (IN); Tapan Bohra, Rajasthan (IN); Adit Krishnan, Chennai (IN)

(21) Appl. No.: 14/553,911

(22) Filed: Nov. 25, 2014

(51) Int. Cl. G06Q 30/02

(52) U.S. Cl. CPC G06Q 30/0243

(57) ABSTRACT

Techniques for multi-channel marketing campaigns are described herein. The techniques enable marketers to determine sequences of chronologically ordered communication channels by which to perform a multi-channel marketing campaign. In some cases, the techniques determine a sequence likely to have a positive result based on historic marketing sequence data and a desired category of the marketer's campaign. The techniques may also determine some number of trial sequences for a trial marketing campaign and then determine a best sequence for a full-scale marketing campaign based on the success of the trial sequences during the trial marketing campaign.

### BACKGROUND

Prior to the advent of digital communication channels, marketers developed marketing campaigns using the few communication channels at their disposal, namely billboards, newsprint, radio, and television. The more-sophisticated of these campaigns attempted to create a synergy between these various channels, such as a radio advertisement informing the public of an improved bake-mix flavor with a television product placement of a happy family eating pancakes made using this improved bake mix.

With the advent of digital communication channels, however, the number of communication channels soared to include email, direct messaging, texting, computer-aided calling, website advertisements, social media, and many others. If a marketer intends to present five marketing activities from 10 different channels, for example, the marketer's campaign can have 10,000 different potential sequences. Selecting a best sequence of 10,000 sequences is either inefficient or inaccurate. Thus, the advent of digital communication channels has made the task of determining better multi-channel marketing campaigns inefficient or inaccurate, if not simply impossible.

### SUMMARY

Techniques for multi-channel marketing campaigns are described herein. The techniques determine sequences of chronologically ordered communication channels by which to perform a multi-channel marketing campaign. In some cases, the techniques determine a sequence likely to have a positive result based on historic marketing sequence data and a desired category of the marketer's campaign. The techniques may also determine some number of trial sequences for a trial marketing campaign and then determine a best sequence for a full-scale marketing campaign based on the success of the trial sequences during the trial marketing campaign.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 illustrates an example digital media environment in which techniques for multi-channel marketing campaigns can be embodied.

FIG. 2 illustrates the local computing device of FIG. 1 in detail.

FIG. 3 illustrates an example sequence having common initiating interactions, intermediate interactions, and purchase interactions.

FIG. 4 illustrates the remote computing device of FIG. 1 in detail.

FIG. 5 is a flow diagram showing a method in an example implementation in which the techniques determine a sequence for a desired category for a desired multi-channel marketing campaign.

FIG. 6 illustrates a category selection interface.

FIG. 7 illustrates a results interface.

FIG. 8 is a flow diagram showing a method in an example implementation in which the techniques determine one or more sequences using trial marketing.

FIG. 9 is a flow diagram showing a method in an example implementation in which the techniques determine a best sequence for a multi-channel marketing campaign by determining trial categories based on a desired category and historic data and then refining those sequences by performing trial multi-channel marketing campaigns.

FIG. 10 illustrates an example dynamic sequence having multiple paths.

FIG. 11 illustrates an example system usable to implement the techniques described herein.

### DETAILED DESCRIPTION

### Overview

This document describes various apparatuses and techniques that determine marketing sequences for multi-channel marketing campaigns. The techniques can receive historic marketing sequence data and associated categories for sequences in this historic data and determine, based on a desired category, a marketing sequence to use in the desired campaign.

Consider, for example, a marketer wishing to sell high-end home furniture through an online sales outlet. The marketer wants to determine how best to sell this furniture through multiple communication channels at his disposal. Further assume that there are ten different communication channels from which to choose. The techniques provide a best sequence or multiple trial sequences that are likely to be successful based on the desired category. The techniques may have sufficient historic data for the desired category, high-end home furniture sold online, or have similar categories to correlate with this desired category, such as high-end appliances, high-end art work, high-end designer kitchens, and so forth. Based on this data and a desired category, the techniques provide, for example, a best marketing sequence of: email, informative display advertisement, computer-aided phone call, and ending with an advertisement to select the online store's website. This sequence of four communication channels having this exact order can be determined as the most successful out of a possible ten to the 10^{th} power (10 billion) possible sequences. As is readily apparent, a marketer cannot determine a best marketing sequence with larger numbers of potential communication channels.

This document now turns to an example digital media environment in which the techniques can be embodied, after which various example methods for performing the techniques are described. Example methods may be performed in the example digital media environment as well as other environments. Consequently, performance of the example methods is not limited to the example digital media environment and the example digital media environment is not limited to performance of the example methods.

### Example Environment

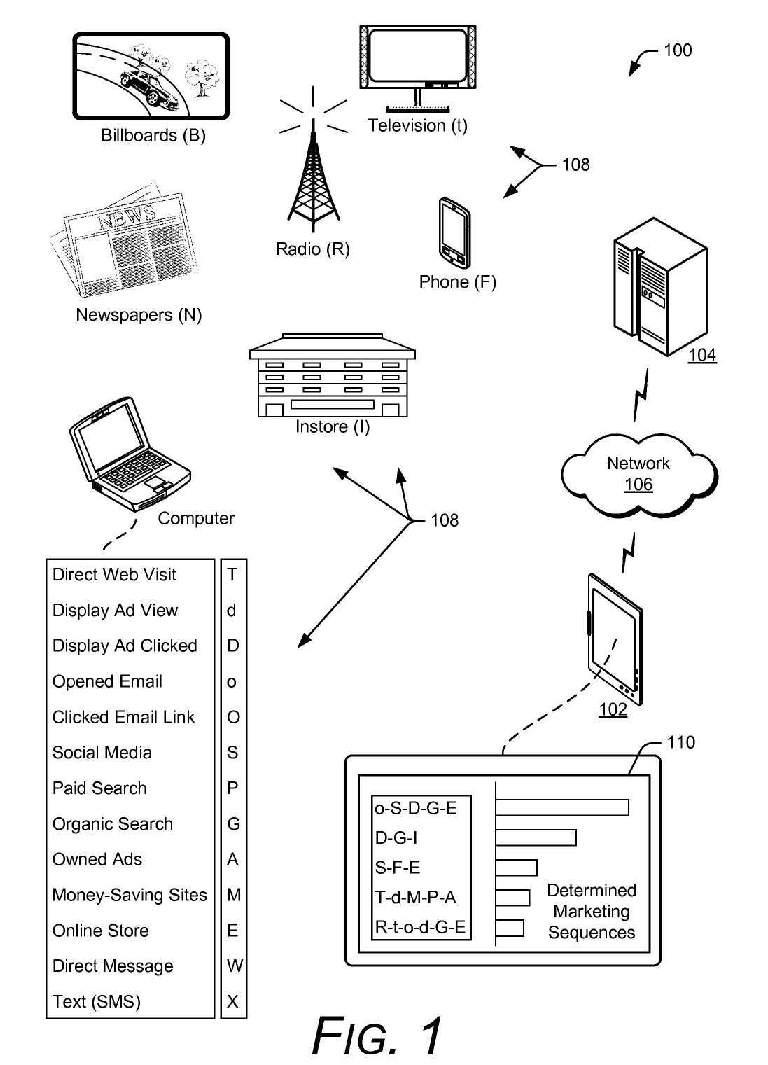

FIG. 1 illustrates an example digital media environment 100 configured to determine sequences of communication channels for use in a digital or mixed multi-channel marketing campaign based on digital information concerning the digital and non-digital communication channels, including digital information indicating orders and successes for historic sequences of these communication channels. In this illustration, the digital media environment includes a local computing device 102, a remote computing device 104, and a network 106 through which the computing devices may communicate, each of which may be configured in a variety of ways.

Generally, remote computing device 104 receives data about marketing sequences and builds, over time, historic data for these various sequences, as well as the category of products, services, and so forth for which the sequences were intended. Local computing device 102 generally receives selection of a category by a marketer, which is then passed to remote computing device 104. Remote computing device 104 determines, based on the desired category and the historic data, one or more marketing sequences likely to be successful, which it then passes back to local computing device 102.

In more detail, digital media environment 100 illustrates available communication channels 108, here illustrated with seventeen digital and non-digital (and mixed digital/analog) communication channels, including: billboards (including in or on a physical store), television (ads or product placement), radio, newspapers (including pamphlets and non-traditional papers), phone calls (including personal or computer-aided calls), physical stores (instore), and computer-enabled communication channels including direct web visit, display ad view, display ad clicked, opened email, clicked email link, social media, paid search, organic search, owned ads, money-saving sites, online stores, direct messaging (e.g., Twitter™), and texting (SMS). Each of these available communication channels 108 has an associated symbol for visual brevity.

Assume, for example, that a marketer selects after-market car parts from various categories through local computing device 102. In response, the techniques (here through remote computing device 104), determine the top-five sequences, shown in user interface 110 in FIG. 1. These top-five sequences include the communication channels used and their order (e.g., o-S-D-G-E for, in order: opened email, social media, display ad clicked, organic search, and online store), as well as a predicted success of each.

Predicted success indicates predicted or probable success in some fashion and by which a marketer may make more-informed decisions about sequences to use for his or her company's marketing campaigns. Thus, while success (e.g., a product sale) is a useful indicator, it may not be the only factor in making decisions. A slightly less successful marketing sequence that is faster (e.g., through fewer communication channels) or costs less to implement can be determined by the techniques and then selected by the marketer. Further, as noted below, multiple top sequences can be selected for a trial multi-channel marketing campaign to further evaluate their success.

Success is not limited to sale of (or failure to sell) a product, as other measures of success can be used, such as a positive impression being made via a user selecting to watch a video explaining a product or a user completing a survey about his or her political opinions of interest to the marketer's company.

Categories, as noted above, encompass a desired and measurable outcome for a marketing campaign, such as sale of a product, a positive impression made through a user watching an advertisement, or a filled-out survey.

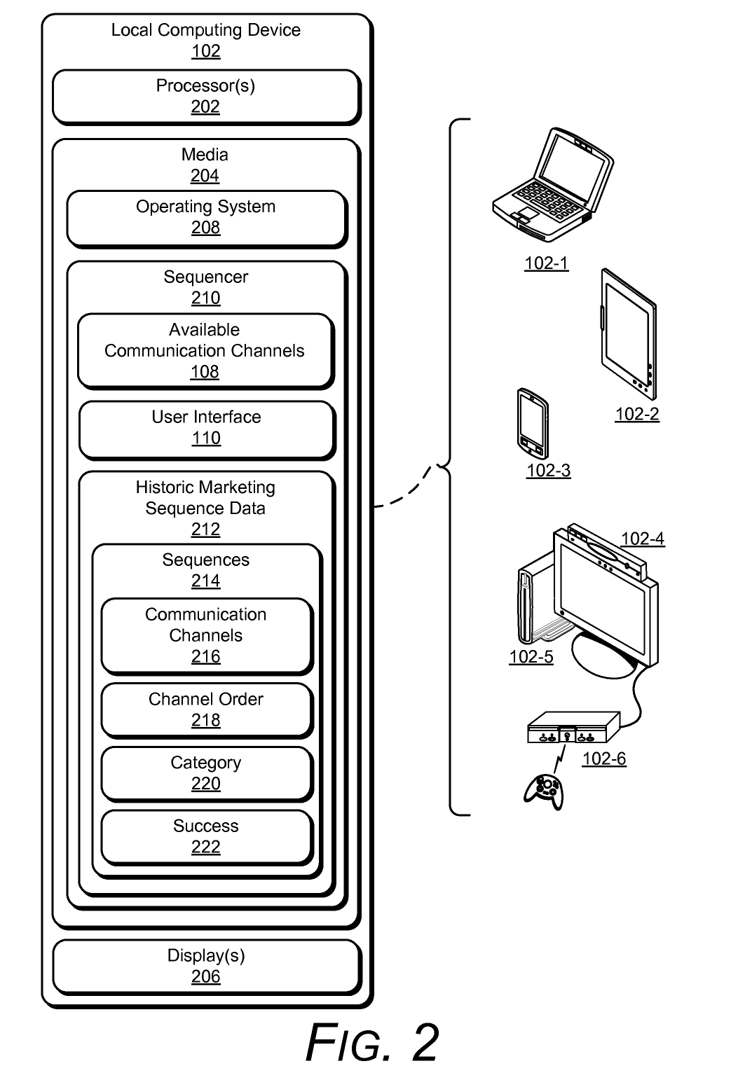

FIG. 2 illustrates an example embodiment of local computing device 102 of FIG. 1, which is illustrated with six examples devices: a laptop computer 102-1, a tablet computer 102-2, a smart phone 102-3, a set-top box 102-4, a desktop computer 102-5, and a gaming device 102-6, though other computing devices and systems, such as servers and netbooks, may also be used.

Local computing device 102 includes or has access to computer processor(s) 202, computer-readable storage media 204 (media 204), and one or more displays 206, four examples of which are illustrated in FIG. 2. Media 204 includes an operating system 208 and sequencer 210. Sequencer 210 includes or has access to available communication channels 108, user interface 110, and historic marketing sequence data 212.

User interface 110 enables selection of a desired category for a desired multi-channel marketing campaign and presentation of a determined best or set of superior marketing sequences, as well as other functions.

Historic marketing sequence data 212 can be received and determined digitally, meaning by computing entities and without requiring interaction from a marketer or other person. For example, one computing entity records a customer opening a link, another records the customer clicking a banner ad, and another the sale of a product or service. All three of these interactions are then received or retrieved to compile historic marketing sequence data 212. By so doing, an almost immeasurable amount of time and effort of a marketer is saved.

Historic marketing sequence data 212 includes, for each of multiple sequences 214, communication channels 216, channel order 218, category 220, and success 222. Sequences 214 are ordered communication channels through with which a marketer may interact with a user, or, in the case of historic marketing sequence data 212, the user has interacted with various communication channels. This interaction can be explicit or implied. Thus, a user's clicking on a display advertisement or a link in an email is explicit, but other implied interactions can also be determined. Consider a case where a user does not click on or otherwise interact with a particular communication channel, such as watching a television program via computer streaming. While the user may not have explicitly interacted with the advertisement, data can be collected indicating that an implied interaction is assumed. Thus, historic marketing sequence data 212 may indicate that a user is likely to have seen the advertisement, and thus be exposed to the desired message.

Communication channels 216 include some or all of available communication channels 108 noted above, though in some cases a marketer excludes some of the channels (such as billboards or newspapers), and thus sequencer 210 may forgo use of sequences having those channels.

Channel order 218 is the order of communication channels 216 in a sequence—this can be chronological from the perspective of when an interaction is attempted by a marketing campaign (e.g., when the email is sent or the radio ad on air) or can be chronological from the perspective of the interaction of the user (e.g., when the user opened the email or heard the radio ad on a later podcast). Some interaction times can be easily measured, such as when a text is opened or a display ad is clicked, while others are more difficult to determine, such as when a radio ad is heard. This is also true of some channels and ways in which data about interactions is tracked, as some communication channels generally, or in some particular manners, are or are not well tracked. A television program that is broadcast on-air may or may not be interacted with but the same program and advertisement can be known when streamed onto a computer by a particular person. Tracking user interactions with communication channels is known in the art and so will not be detailed herein.

Category 220 includes at least one category for each sequence 214, though multiple categories 220 can be appropriate for a particular sequence 214, such as a sequence in which a particular person bought a replacement windshield for his four-wheel drive jeep being categorized under automobile maintenance, after-market automobile parts, and all-terrain vehicle parts. More generally, a category can encompass any desired and measurable outcome for a marketing campaign, such as a type or class of product, relationship, interaction, or service. Thus, a category may include furniture sales, a user watching a video explaining a new gymnasium's services, starting, renewing, or not ceasing a current relationship (e.g., a magazine subscription or a monthly pay-for-use software program), a sale of a service, an interaction where a person simply visits a new store or restaurant, use of a coupon at a particular location, a sale or servicing on any item (e.g., an oil change), a positive (or any) review of something performed by the user, reading of an article on line, filling out a survey, and so forth. If a marketer has a desired result that can be measured, it can be a category.

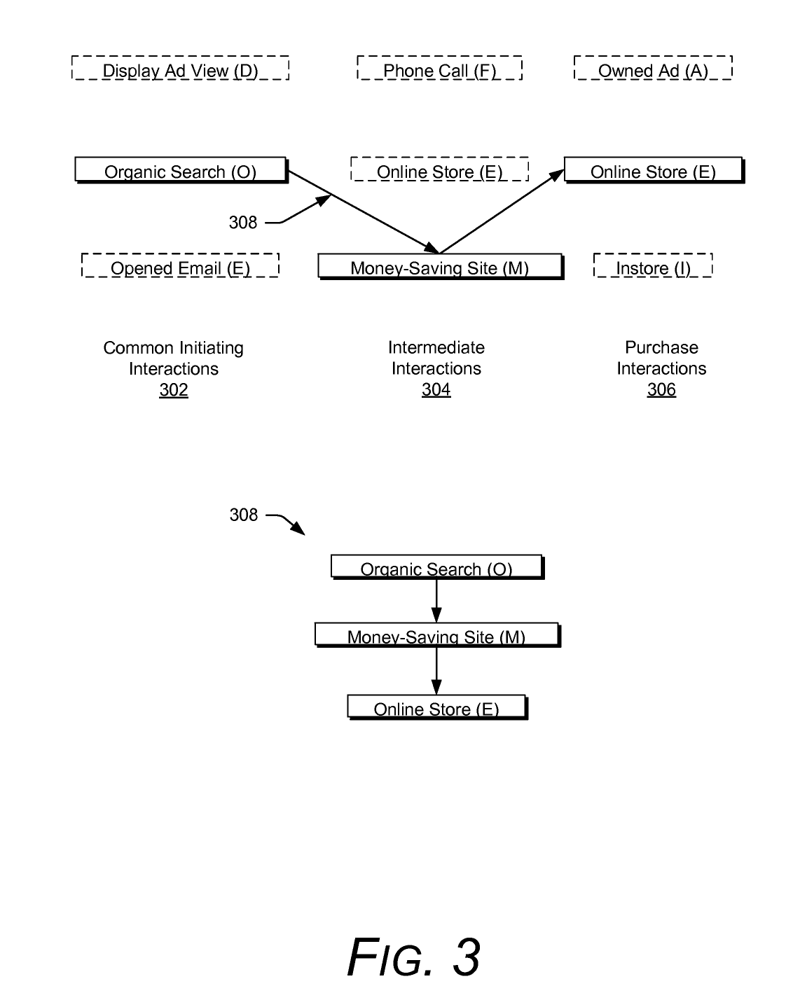

By way of illustration of potential sequences that a person may undergo and their corresponding historic data, consider FIG. 3. FIG. 3 shows common initiating interactions 302, intermediate interactions 304, and purchase interactions 306. This is a simplification, but is useful in understanding sequences and the data that can be associated with each sequence. Thus, if a person performed an organic search for a chrome muffler for a motorcycle, then visited a money-saving website for a best price, and then purchased online from a selected least-expensive online store, muffler-purchase sequence 308 would be O-M-E (communication channels O, M, and E), the order is O, then M, then E, the category is motorcycle parts, and the success is item purchased.

In somewhat more detail, consider six example sequences 214 in Table 1, below, which are assumed to have a same category. These are but six of many thousands, millions, or even billions of sequences 214 that may be used as part of historic marketing sequence data 212.

TABLE 1

| Customer ID | Sequence | Success |
|---|---|---|
| 1 | O-W-A-D | Yes |
| 2 | D-P-A-M-W | Yes |
| 3 | D-P-A | Yes |
| 4 | P-M-A-O-D-W | No |
| 5 | S-W-A-G | Yes |
| 6 | O-P-M-A-M-W | No |

Sequencer 210 determines, for a desired category, a determined best or set of superior marketing sequences. In some cases sequencer 210 does so through correlating the desired category with one or more same or similar categories that have historically been successful (e.g., categories 220 of sequences 214). Sequencer 210 may also or instead determine and perform trial multi-channel marketing campaigns, whether or not sequencer 210 first determines superior marketing sequences for that trial campaign. Sequencer 210 may operate, in whole or in part, from local computing device 102 and remote computing device 104.

In more detail, sequences 214 can be represented, and determination of best or better sequences made, as follows through example notation. First, let F be the set of possible interactions {C₁, C₂, . . . , C_{J}}, such as an opened email, viewed display ad, or clicked paid search. Interactions of a customer are chronologically ordered and denoted by a sequence Sᵢ of length iₖ by:

<I₁,I₂, . . . ,Iᵢₖ>

where I_{J}εΓ for all j=1, . . . , iₖ. Further, the sequence Sₗ denoted by:

<I^{l}₁,I^{l}₂, . . . ,I^{l}ₗₖ>

is contained in sequence Sₘ denoted by:

<I^{m}₁,I^{m}₂, . . . ,I^{m}ₘₖ>

if

I^{l}₁₌I^{m}ₘ₁,I^{l}₂₌I^{m}ₘ₂, . . . ,I^{l}ₗₖ₌I^{m}ₘₗₖ, for m₁<m₂< . . . <mₗₖ≦mₖ.

For example, the sequence Sₐ₌<S, A> is contained in the sequence:

S_{b=}<S,W,A,G>

however, it is not contained in the sequence:

S_{c=<}S,T,U,D>.

Next, let D denote {S₁, S₂, . . . , Sₙ} a database of user activity sequences. A sequence Sₗ supports a sequence Sₘ if sequence Sₘ is contained in sequence Sₗ. The support for a sequence is defined as the fraction of total sequences that support this sequence. For example, in Table 1 as noted above, the sequence <P, A, W> has a support of 3/6.

Further, define a frequent sequence as a sequence that has support greater than or equal to a certain user-specified minimum support (minsup). A frequent maximal sequence (maxlen) is one that is not strictly contained in another frequent sequence. In Table 1, if minsup=0.2, the sequence <S, A> fails to meet the minimum support. The sequence <P, A> has a support of 4/6. However, <P, A> is not a frequent maximal sequence because it is contained in <P, A, W>, which is a frequent sequence.

Note that some sequences may end with a purchase, which are called a purchase sequence for this ongoing example. In other words:

Sᵢ=<I₁,I₂, . . . ,Iᵢₖ>

such that Iᵢₖ is a purchase event. Also note that a sequence cannot have a purchase in its interior, if it does, such sequences are broken into separate sequences, each with at most one purchase event. A purchase may have additional attributes like revenue, product type, mode of purchase, and so on. Denote a mapping of purchase events to classes of objectives, for example:

F(Iᵢₖ)ε{O₁, . . . ,O_{K}}.

An objective is a marketing goal that the marketer may envision for customer sequences, for example, one objective could be purchase of product type “furniture”, with a “high” revenue that happen “online”. Also, for a purchase sequence Sᵢ, define the function (without the purchase event):

antecedent(Sᵢ)=<I₁,I₂, . . . ,Iₖ₋₁> the sequence Sᵢ

Therefore, one particular algorithm following this example can be used to mine for high confidence sequences:

Algorithm 1

Require: Two database of sequences D and D(O)
1: Supp ← VMSP (D(O), minsup, maxlen)
2: Count ← empty dictionary
3: for seq in Supp do
4: antseq ← antecedent(seq)
5: for x in D do
6: if antseq is contained in x then
7: Count[seq]++
8: end if
9: end for
10: end for
11: Conf ← empty dictionary
12: for seq in Supp do
13: Conf[seq] = Supp[seq] / Count[seq]
14: end for

Here the database of sequences D(O) (e.g., historic marketing sequence data 212) is denoted as observed sequences that satisfy objective O, for example, sequences ending in high revenue online furniture purchases. Algorithm 1 outlines the steps to compute the support and confidence of sequences. In the first step, the VMSP sub-routine is called on the sequence database D(O), this finds frequent maximal sequences along with a specified minimum support. Such sequences end with the objective O. Next the techniques take the antecedent of the sequence and compute the support for this sequence in the entire data (D). The ratio of the two frequencies gives the confidence of the sequence leading to the objective of interest. This approach is of various approaches usable by sequencer 210 of FIG. 2 to find the best or better sequences likely to lead to a certain objective. It also gives a measure of the chance of this objective being satisfied by the sequence. As noted above, when a marketer selects a desired category, the objective noted herein is a successful sequence for some species of the genus for a same or similar category to that of the desired category. Thus, a sale of a particular product (e.g., shaving cream) can be a measured, successful objective, which is a species of the category men's grooming.

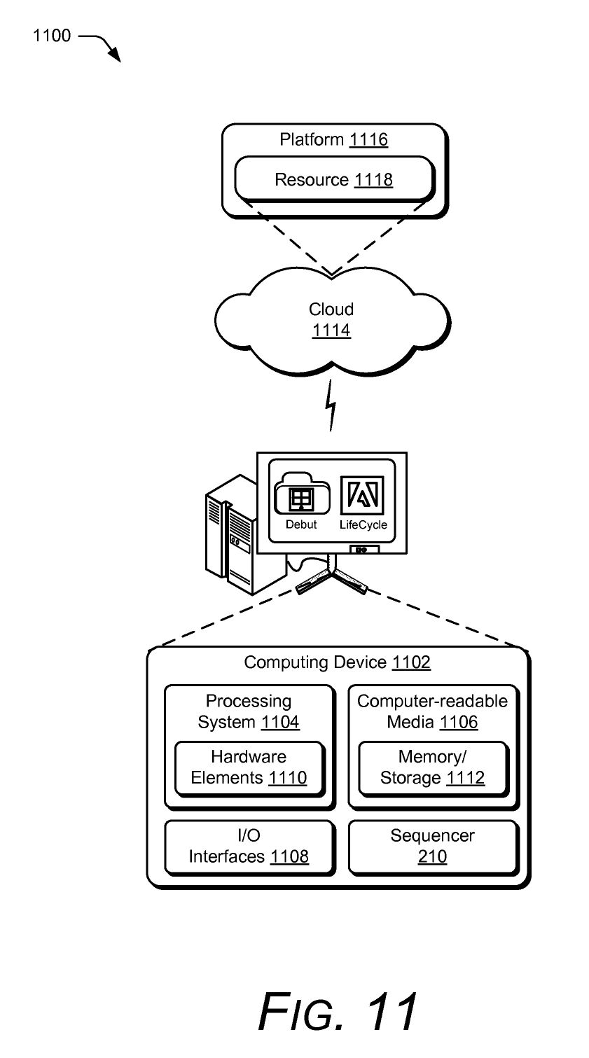

Returning to FIG. 2, local computing device 102 may be configured as a full resource device with substantial memory and processor resources (e.g., personal computers, game consoles), a mid-resource device with moderate memory and resources (e.g., a netbook), or a low-resource device with limited memory and/or processing resources (e.g., mobile devices, automobile computing devices, computers within children's toys, kitchen appliances with computing abilities). Local computing device 102 may be representative of one or a plurality of different devices, such as multiple servers utilized by a business to perform operations “over the cloud” as further described in relation to FIG. 11.

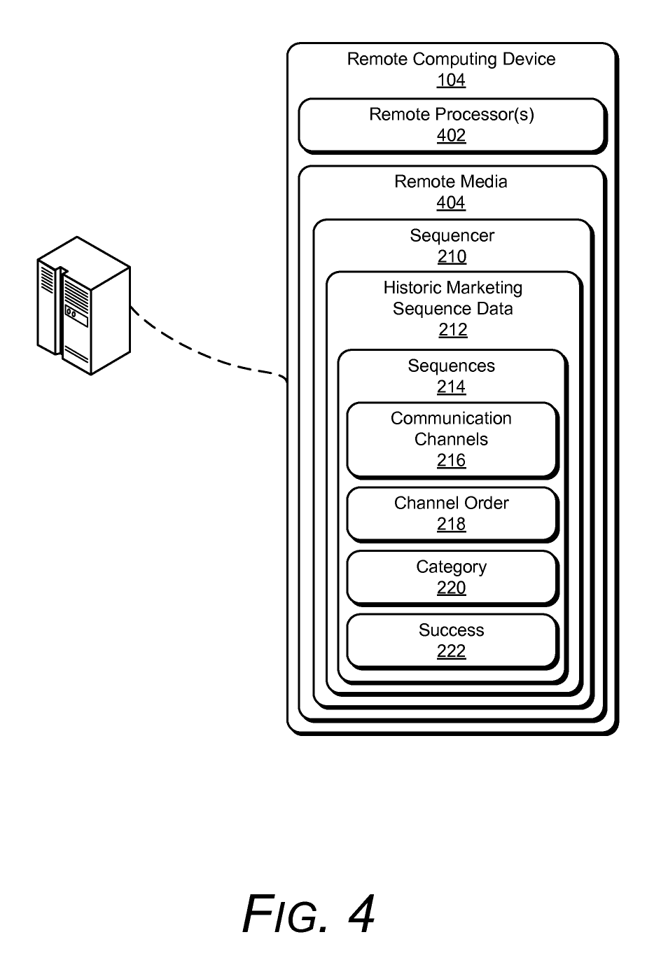

FIG. 4 illustrates an example embodiment of remote computing device 104. Remote computing device 104 is shown as a singular entity for visual brevity, though multiple devices may instead be used. Remote computing device 104 includes or has access to remote processor(s) 402 and remote computer-readable storage media 404 (remote media 404). Remote media 404 includes or has access to, in some cases, sequencer 210 and historic marketing sequence data 212. Thus, the operations of sequencer 210 can be performed at remote computing device 104, local computing device 102, or some combination of these or other entities.

Ways in which entities and components of FIGS. 1, 2, and 4 act and interact are set forth in greater detail below. The components illustrated for local computing device 102 and remote computing device 104 can be separate or integrated and operate as part of a web platform as described in relation to FIG. 11, for example.

### Example Methods

The following discussion describes methods enabling multi-channel marketing campaigns. Aspects of each of the methods may be implemented in hardware, firmware, or software, or a combination thereof. The methods are shown as a set of blocks that specify operations performed by one or more devices and are not necessarily limited to the orders shown for performing the operations by the respective blocks. In portions of the following discussion, reference will be made to FIGS. 1-4, which are for illustration rather than limitation.

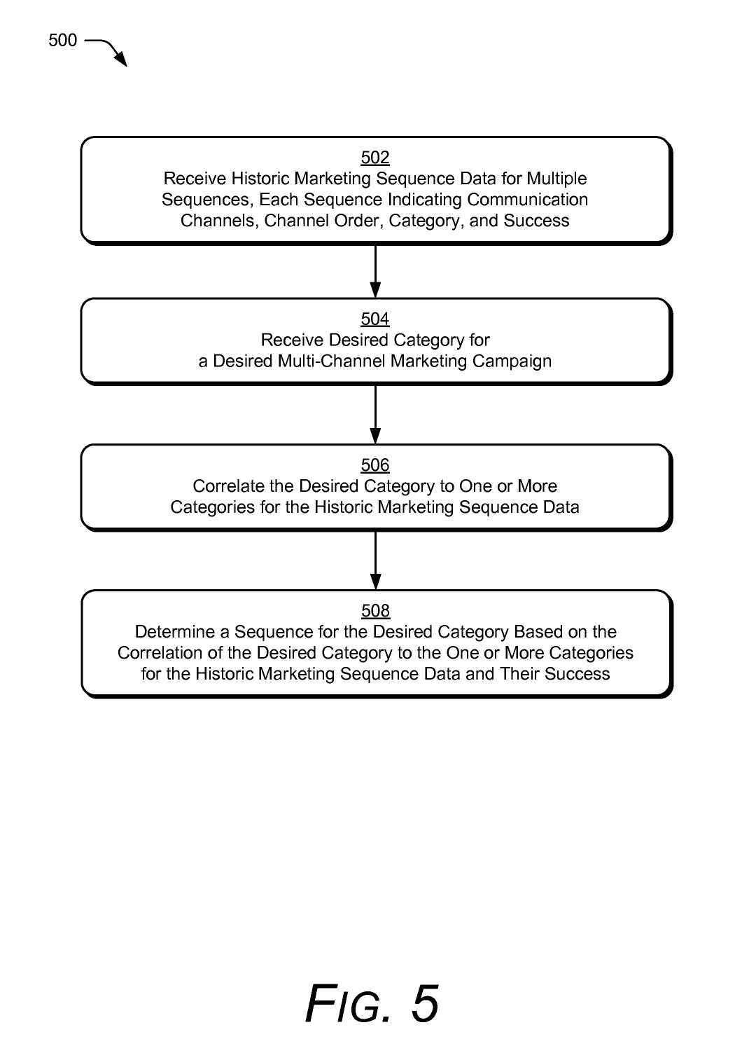

FIG. 5 depicts method 500 in an example implementation in which the sequencer 210 determines a sequence for a desired category for a desired multi-channel marketing campaign. By so doing, a marketer can accurately and efficiently select how to market a product, service, or further some other desired outcome.

Block 502 receives historic marketing sequence data for multiple sequences, each sequence indicating communication channels included in the sequence, an order for those communication channels in the sequence, a category of the sequence, and success of the sequence. This historic marketing data can be refined and categorized to permit faster determination of sequences for desired campaigns and can be stored at various different locations, such as remote computing device 104.

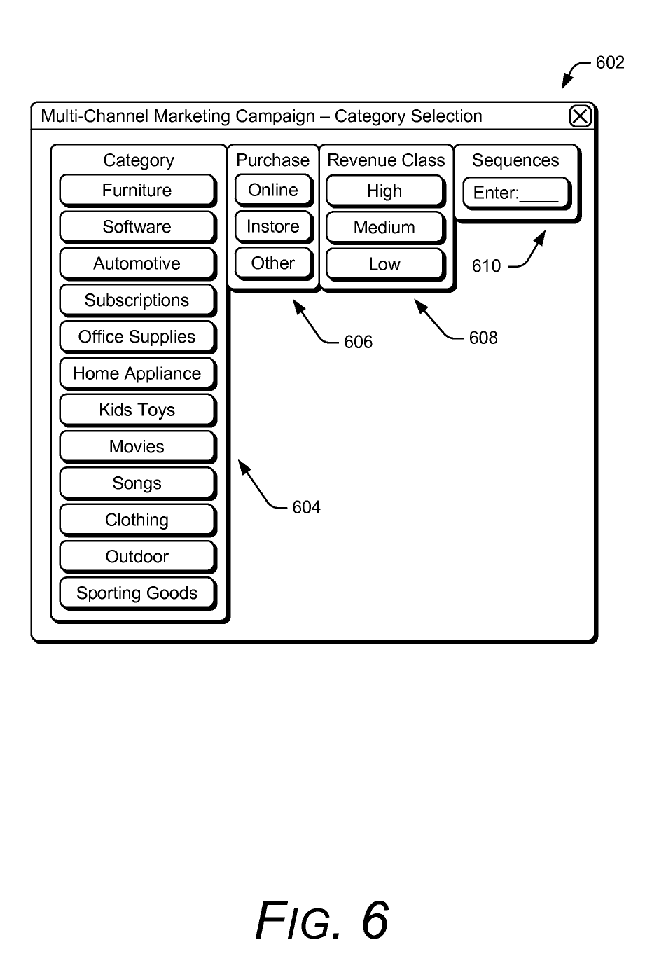

By way of example, assume that a marketer wishes to sell white printer paper online. The marketer can select a same or similar category from a provided list, or simply entered in text for his or her category and the techniques can compare and correlate or provide a list of likely selectable categories. While a single category can be selected, various parameters for the category can also be chosen. An example user interface in which a category can be selected is illustrated in FIG. 6 at category selection interface 602. Here categories and other parameters are selected through drop-down lists, each shown expanded for clarity, namely category list 604, purchase list 606, revenue class 608, and desired number of sequences 610 (here a date-entry field allowing integers from 1-100). Assume that the marketer selects Office Supplies for the category, Online for the manner of purchase, Low for the revenue class, and enters five sequences for a desired number of results.

Block 504 receives a desired category for a desired multi-channel marketing campaign. Continuing the ongoing example, sequencer 210 receives, through user interface 602, selection of Office Supplies as well as the above-noted parameters. While not shown, each of the categories (only a few are illustrated) can be further broken down into subcategories, such as, for Office Supplies, paper, pens, folders, printer ink, keyboards, sticky notes, and so forth.

Block 506 correlates the desired category to one or more categories for the historic marketing sequence data. The desired category may or may not have sufficient data—a category for selling pet massage services, for example, is unlikely to have sufficient historic data. Some similar categories, however, may be used and provide excellent results, such as high-end cat scratching posts, high-end dog training classes, and high-end collars and pet clothing. In the ongoing example, the category selected has already been pre-selected as having sufficient data, and thus correlating is simply to sequences having the same category. While not required, additional categories may be used to alter the results, such as to weight office supply category sequences highly but to also correlate the selected office supply category to a lesser degree with a Printer Sales and Printer Services categories, for example.

Block 508 determines a sequence for the desired category for the desired multi-channel marketing campaign, the determination based on the correlation between the desired category and the success of one or more categories for the historic marketing sequence data. The determined sequence for the desired category includes multiple determined communication channels and a determined order for the multiple determined communication channels. Sequencer 210 may provide multiple sequences or a best sequence by which to market through multiple channels, such as o-S-D-G-E for, in order: opened email, social media, display ad clicked, organic search, and online store.

Furthermore, sequencer 210 may determine the sequences based on a statistical measure of confidence, such as a confidence interval having upper and lower confidence bounds. Sequencer 210 can rank sequences based on a mid-point of these upper and lower confidence bounds, thereby determining a list of sequences based on that determined rank. In some cases, however, this statistical measure of confidence can be used to determine multiple sequences, such as those having overlapping upper or lower confidence bounds. A measure of risk may also be used in the determination, such as selecting to rank a sequence having a lower measure of likely success above a sequence having a higher measure of likely success when the confidence of the higher-measuring sequence has a lower confidence bound. This can be the case, for example, when a number of sequences analyzed from historic marketing sequence data and on which the higher-measuring sequence is determined is lower or substantially lower than another number of sequences on which the lower-measuring sequence is determined.

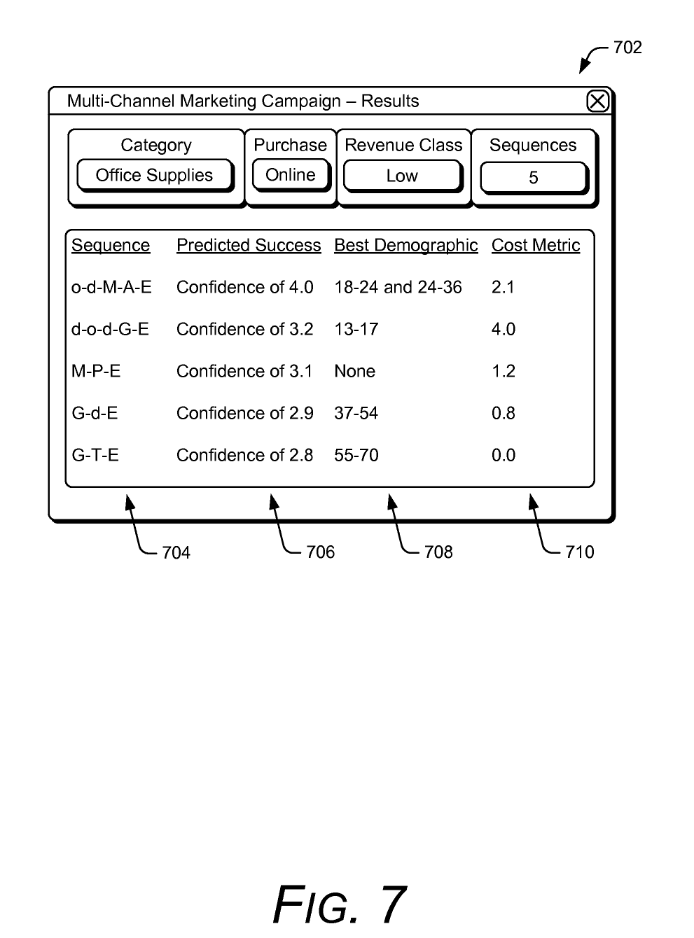

Concluding the ongoing example, sequencer 210 provides the five best sequences for the desired category: Office Supplies; the purchase manner: Online, and the revenue class: Low. The resulting sequences are illustrated at results interface 702 of FIG. 7. As noted, a marketer may select one or more of these sequences or perform a trial run, which can be implemented through sequencer 210.

Note also that particular communication channels can be selected before or after sequences are determined—such as to simply exclude those with undesired communication channels or to exclude sequences prior to showing the results so that all five results are usable. Some marketing campaigns, for example, only select automated communication channels—those without a direct human involvement (e.g., a personal call or personal sale). Others are only for digital communication channels, and thus exclude physical newspapers and billboards, for example.

Furthermore, sequencer 210 may determine sequences also based on demographics. A marketer may select, such as through user interface 110 or 602, a desired demographic. Sequencer 210 may then provide the best sequences for that demographic. Furthermore, a marketer may wish to know which sequences are best for which demographics so that the marketer may direct different sequences to different demographic groups. Thus, persons 54-70 may react better to a computer-aided phone call or email, while persons 18-24 react better to direct messaging and text messages.

The techniques need not require demographic or channel selection prior to providing sequences, however, as providing a larger number of sequences along with their demographic ranking and channels included permit easy selection of preferred sequences by the marketer. The techniques may also include other information to aid in the marketer's selection, such as predicted success and cost. Cost can be computed based on costs associated with each communication channel, some of which have no or little marginal costs, such as a sale through company's own online store. This is illustrated in FIG. 7 at sequences 704, predicted success 706 (shown as a statistical measure of confidence, though ranking or percentage likelihood may instead be used), best demographic 708, and cost metric 710. By so doing, the marketer may then select which sequences to use for which demographic group, or select to perform a trial on two or more of these sequences, or simply select a best fit for the marketer.

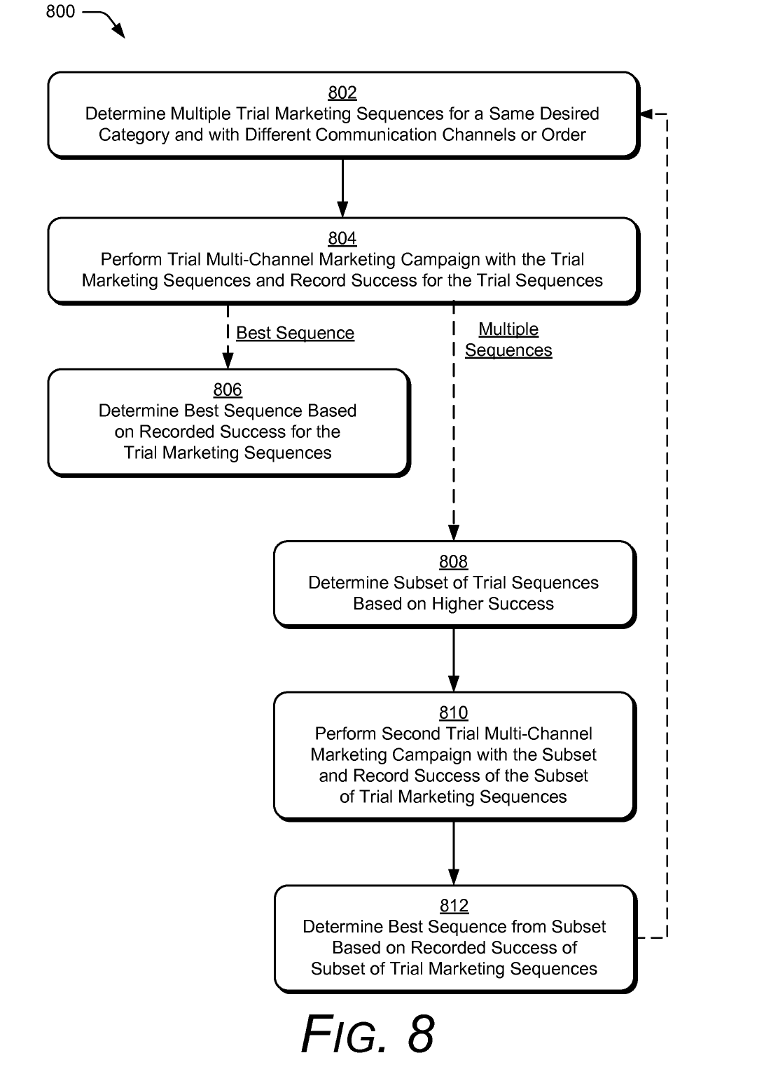

FIG. 8 depicts method 800 in an example in which the techniques determine one or more best sequences using trial marketing.

Block 802 determines multiple trial marketing sequences, each of the trial marketing sequences having a same desired category and different communication channels or orders for communication channels. These sequences can have different communication channels and/or a different order for the communication channels, such as O-T-o-E, O-o-T-E, or O-T-d-E. These trial marketing sequences can be determined by sequencer 210, such as using the results of method 500. Or, a marketer may select them through user interface 110, and, assuming that these sequences are capable of being automated (e.g., do not require human action to set up, such as calling a newspaper or television company), can use these trial sequences.

Block 804 performs a trial multi-channel marketing campaign with the multiple trial marketing sequences while recording success for each of the trial marketing sequences. Also, as noted in part above, performing the trial multi-channel marketing campaign can be performed multiple times with a different demographic of persons (or once and demographics simply recorded along with success), which permits determination of a best sequence specific to one or more of the different demographics of persons.

Following block 804, sequencer 210 may follow a best path to block 806 or a multiple-sequence path to blocks 808, 810, and 812. Note that sequencer 210 may perform blocks 808, 810, and 812 and then return to block 802 to use the sequences determined at block 812 as a second trial run.

Block 806 determines a best sequence based on the recorded success for each of the trial marketing sequences. Sequencer 210 is capable of receiving indications of success, such as users failing to purchase, purchasing, or otherwise having a positive or negative outcome from the trial sequence.

Optionally, block 808 determines a subset of the trial marketing sequences based on having a higher success relative to trial marketing sequences not of the subset. By so doing, a second trial can be performed or a set of sequences can be provided for selection by the marketer, similar to as shown in FIG. 7. In such a case method 800 may perform operations of method 500, for example, rather than blocks 810 and 812.

Block 810 performs a second trial multi-channel marketing campaign with the subset of the multiple trial marketing sequences. The second trial includes recording success for each of the subset of the trial marketing sequences.

Block 812 determines, based on the recorded success for each of the subset of the trial marketing sequences, a best sequence of the subset of the trial marketing sequences or some further subset of the subset of the second trial.

By way of example, assume that a marketer selects manually five sequences that she considers likely to succeed (numbered 1-5 below), but also requests another 10 to be determined by the techniques (numbered 6-15). With a trial of these 15 different sequences each to 1,000 persons, assume that the following is the results, shown in Table 2.

TABLE 2

| Number | Sequence | % Success |
|---|---|---|
| 1 | O-W-A-D | 1.0 |
| 2 | D-P-A-M-W | 0.4 |
| 3 | D-P-A | 1.6 |
| 4 | P-M-A-O-D-W | 0.7 |
| 5 | S-W-A-G | 0.1 |
| 6 | O-P-M-A-M-W | 2.0 |
| 7 | o-S-D-G-E | 1.4 |
| 8 | O-T-o-E | 1.9 |
| 9 | O-T-M-E | 0.8 |
| 10 | o-S-A-G | 1.1 |
| 11 | O-T-d-E | 0.9 |
| 12 | D-A-E | 2.7 |
| 13 | O-E | 2.3 |
| 14 | o-M-E | 1.4 |
| 15 | t-R-O-E | 0.6 |

Based on these results, the marketer was correct to select five sequences manually, as one of them, D-P-A performed well (1.6%), along with the top four determined by sequencer 210, which are: D-A-E (2.7%); O-E (2.3%), O-P-M-A-M-W (2.0%), and O-T-o-E (1.9%). Assume that the marketer then decides to use three of these five based on demographics, costs, and speed of implementation, etc. for a full-scale multi-channel marketing campaign to 20 million people.

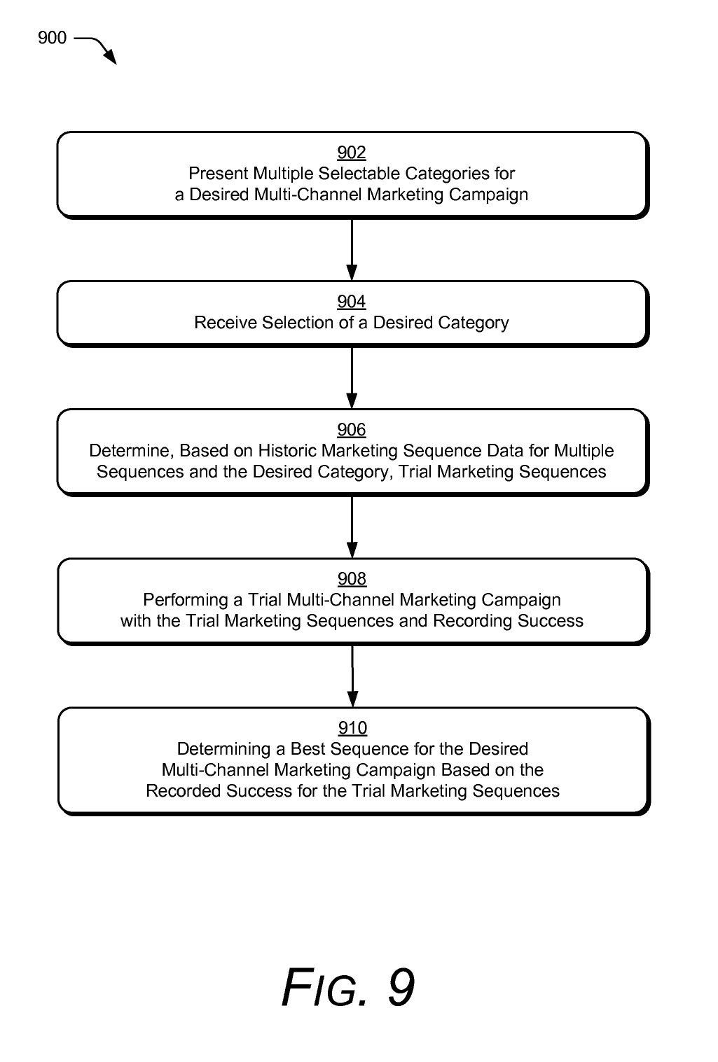

FIG. 9 depicts method 900 in an example in which the techniques determine a best sequence for a multi-channel marketing campaign by determining trial categories based on a desired category and then refining those sequences based on performing trial multi-channel marketing campaigns.

Block 902 presents multiple, selectable categories for a desired multi-channel marketing campaign. These selectable categories can be presented, and selection enabled, through a user interface, such as category interface 602 of FIG. 6.

Block 904 receives selection of a desired category for a desired multi-channel marketing campaign. Example selection is shown in FIGS. 6 and 7, with FIG. 6 at category interface 602 showing drop down and data-entry selections and FIG. 7 at results interface 702 showing five resulting sequences and the selected category and parameters.

Block 906 determines, based on historic marketing sequence data for multiple sequences and the desired category, trial marketing sequences for the desired category. As noted, this determination can include determining measures of confidence for these trial marketing sequences. Determining the best sequence can include performing multiple trial multi-channel marketing campaigns with different or progressively smaller subsets of the trial marketing sequences. Thus, a subset is selected based on success of the subset in the first trial campaign and the best sequence determined from a trial of that subset.

Further, determining the trial marketing sequences can include correlating the desired category to a same category of sequences of the historic marketing data for multiple sequences or correlating the desired category to multiple similar categories of sequences of the historic marketing data for multiple sequences (or both). Examples of this are set forth above.

Block 908 performs a trial multi-channel marketing campaign with the trial marketing sequences. As part of this trial success for each of the trial marketing sequences is recorded. Sequencer 210 may perform the trial multi-channel marketing campaign digitally, automatically, and without interaction from the marketer or explicit recording by a customer performing the trial. Thus, sequencer 210 can simply perform the trial quickly and easily through communication channels that do not require a human's interaction to communicate through the communication channels. This saves the marketer substantial time and effort, as the marketer need not send the emails, send the texts, or record a customer's purchase or non-purchase of an item for the trial sequences. Each of these actions can be caused automatically by sequencer 210 and success recorded.

Block 910 determines a best sequence based on the recorded successes for the trial marketing sequences. As noted, block 910 can be direct from operations at block 908 or through further iteration. Sequencer 210 can wait to determine the best sequences until a statistically relevant quantity of successes are recorded for the trial marketing sequences during the trial multi-channel marketing campaign. Thus, sequencer 210 can record dozens if not hundreds of successes for each of the trial marketing sequences prior to determining the best sequence.

By way of example, consider a case where a marketer wishes to have current customers continue their magazine subscriptions. The marketer then selects, at category interface 602, a Subscription category, with a purchase parameter of Other, at which time sequencer 210 provides a second drop down or a data-entry field, at which time the marketer selects Continuation of Current Subscription (not shown in FIG. 6). The marketer selects a Low revenue class and 15 sequences. Sequencer 210 then determines 15 superior sequences, which sequencer 210 uses in a trial multi-channel marketing campaign. Assume that, for each of the 15 trial sequences, the marketer selects to try them on 100 magazine subscribers, for a total trial of 1,500 subscribers. While even millions of sequences can be known even in the subscription category and used in determining the trial sequences (e.g., at historic marketing sequence data 212 of FIGS. 2 and 4), using the trial may further refine from 15 sequences down to a few that are best for a full multi-channel marketing campaign. Assume that after this trial campaign that four of the 15 are determined to be the best sequences, two for the most-desired demographic and two others that each are well suited to different demographics of customers. By so doing, the techniques permit a marketer to quickly, easily, and accurately determine sequences that, with a high degree of confidence, will be most successful for the campaigns desired goal.

### Dynamic Sequences

In the above examples, sequences for use in a multi-channel marketing campaign are determined based at least in part on interactions by a user throughout the sequence, even if some of these interactions are implied rather than explicit. In some cases, however, the techniques determine dynamic sequences, which may improve marketing success. A dynamic sequence has one or more alternative options by which to adjust the communication channels based on an interaction or lack thereof by a user of the dynamic sequence. Rather than a particular marketing sequence failing when some communication channel fails to cause an interaction by a user, the sequence is instead dynamic and able to change in response to this failure. The dynamic sequences can be based on historic marketing sequence data 212 and determined by sequencer 210. Implementation of alternative paths, as described below, can be responsive to a negative interaction, a failure to proceed to another communication channel in the primary sequence path, or simply use of every path without regard to tracking interactions.

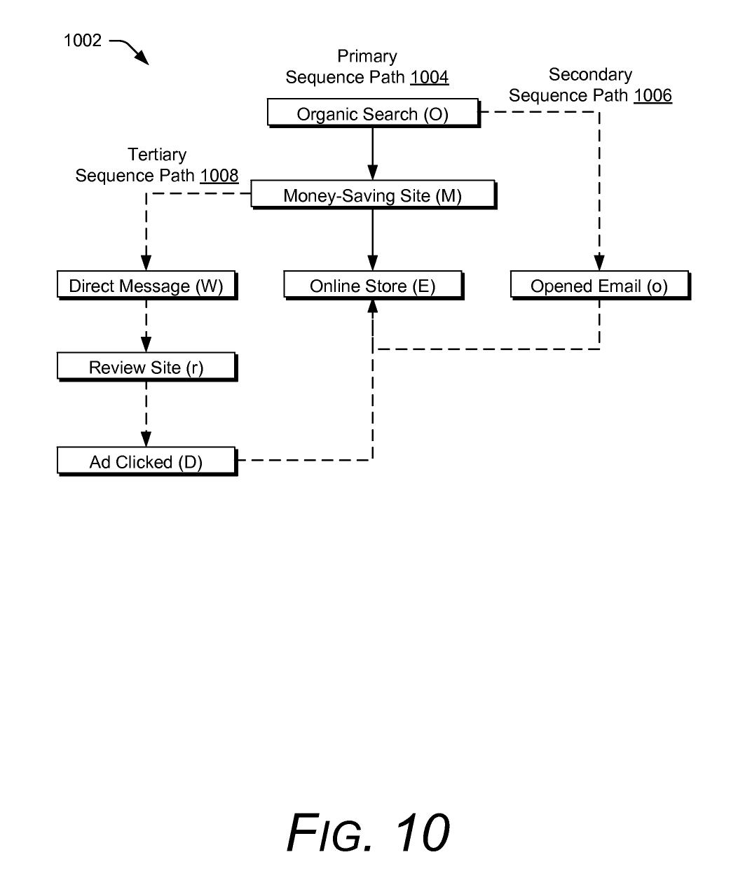

By way of example, consider FIG. 10, which illustrates a dynamic sequence 1002. Dynamic sequence 1002 includes a best sequence path 1004 but permits other paths should an interaction fail at some point in best sequence path 1004. Here the best sequence path 1004 (shown with two solid arrows) is an organic search, then a visit to a money-saving site, and then a visit to the marketer's own online store. Assume, however, that some users fail to visit the money-saving site. An alternative path is then used in which the user is emailed about the organic search results, with secondary sequence path 1006. If the user opens the email, there is a link to the online store. If the user visits the money-saving site but does not then proceed to the online store, however, a tertiary sequence path 1008 can be followed. With this path, a direct message is sent to the user having a link to reviews of the product that the user searched and, if the user interacted more with the money-saving site, that the user investigated through the money-saving site. The reviews website has a display ad for the online store, which if selected results in the online store again being the end communication channel.

This dynamic sequence can be determined based on successful sequences that share at least a common communication channel with the best sequences (e.g., both start with organic search and end with online store). Sequencer 210 may, however, provide a dynamic sequence that has a highest aggregate success confidence for the various paths (e.g., 1004 plus 1006 plus 1008), which may be greater than aggregates for other dynamic sequences but that may have a primary path that is of lower success than some of the primary paths of the other dynamic sequences. For example, assume that while O-M-E (path 1004) is less likely to be successful that P-M-E (not shown) but that O-M-E plus O-o-E (path 1006) plus O-M-W-D-r-E (path 1008) is more likely to succeed than P-M-E plus its alternative paths.

### Example System and Device

FIG. 11 illustrates an example system generally at 1100 that includes an example computing device 1102, which is representative of one or more computing systems and/or devices that may implement the various techniques described herein. This is illustrated through inclusion of sequencer 210, which is configured to determine sequences for a multi-channel marketing campaign. Computing device 1102 may be, for example, a server of a service provider, a device associated with a client (e.g., a client device), an on-chip system, and/or any other suitable computing device or computing system.

Computing device 1102 as illustrated includes a processing system 1104, one or more computer-readable media 1106, and one or more I/O interface 1108 that are communicatively coupled, one to another. Although not shown, computing device 1102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

Processing system 1104 is representative of functionality to perform one or more operations using hardware. Accordingly, processing system 1104 is illustrated as including hardware element 1110, which may be configured as processors, functional blocks, and so forth. This may include implementation in hardware as an application-specific integrated circuit or other logic device formed using one or more semiconductors. Hardware elements 1110 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

Computer-readable storage media 1106 is illustrated as including memory/storage 1112. Memory/storage 1112 represents memory/storage capacity associated with one or more computer-readable media. Memory/storage 1112 may include volatile media (such as random access memory (RAM)) and/or nonvolatile media (such as read only memory (ROM), Flash memory, optical disks, magnetic disks, and so forth). Memory/storage 1112 may include fixed media (e.g., RAM, ROM, a fixed hard drive, and so on) as well as removable media (e.g., Flash memory, a removable hard drive, an optical disc, and so forth). Computer-readable media 1106 may be configured in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, computing device 1102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The entities described herein (e.g., sequencer 210 and user interface 110) generally represent software, firmware, hardware, or a combination thereof. The features of the techniques described herein are platform-independent, meaning that the techniques may be implemented on a variety of commercial computing platforms having a variety of processors.

An implementation of the described entities and techniques may be stored on or transmitted across some form of computer-readable media. The computer-readable media may include a variety of media that may be accessed by computing device 1102. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of computing device 1102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1110. Computing device 1102 may be configured to implement particular instructions and/or functions corresponding to the software and/or hardware modules. Accordingly, implementation of a module that is executable by computing device 1102 as software may be achieved at least partially in hardware, e.g., through use of computer-readable storage media and/or hardware elements 1110 of processing system 1104. The instructions and/or functions may be executable/operable by one or more articles of manufacture (for example, one or more computing devices 1102 and/or processing systems 1104) to implement techniques, modules, and examples described herein.

The techniques described herein may be supported by various configurations of computing device 1102 and are not limited to the specific examples of the techniques described herein. This functionality may also be implemented all or in part through use of a distributed system, such as over a “cloud” 1114 via a platform 1116 as described below.

Cloud 1114 includes and/or is representative of platform 1116 for resources 1118. Platform 1116 abstracts underlying functionality of hardware (e.g., servers) and software resources of cloud 1114. Resources 1118 may include applications and/or data that can be utilized while computer processing is executed on servers that are remote from computing device 1102. Resources 1118 can also include services provided over the Internet and/or through a subscriber network, such as a cellular or Wi-Fi network.

Platform 1116 may abstract resources and functions to connect computing device 1102 with other computing devices. Platform 1116 may also serve to abstract scaling of resources to provide a corresponding level of scale to encountered demand for resources 1118 that are implemented via platform 1116. Accordingly, in an interconnected device embodiment, implementation of functionality described herein may be distributed throughout system 1100. For example, the functionality may be implemented in part on computing device 1102 as well as via platform 1116 that abstracts the functionality of cloud 1114.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital media environment for determining a sequence of digital or mixed digital and non-digital communication channels for use in a digital or mixed multi-channel marketing campaign based on digital information concerning the digital and non-digital communication channels, a method comprising:
receiving historic marketing sequence data for multiple sequences, each sequence indicating communication channels included in the sequence, an order for those communication channels in the sequence, a category of the sequence, and a success of the sequence;
receiving a desired category for a desired multi-channel marketing campaign;
correlating the desired category to one or more categories of the sequences of the historic marketing sequence data; and
determining a sequence for the desired category for the desired multi-channel marketing campaign, the determining based on the correlation between the desired category and the success of the one or more categories of the sequences of the historic marketing sequence data, the sequence for the desired category including multiple determined communication channels and a determined order for the multiple determined communication channels.

2. The method as described in claim 1, wherein the desired category indicates a type of product, relationship, interaction, or service.

3. The method as described in claim 1, wherein the success of the multiple sequences of the historic marketing sequence data is a sale or failure to sell a product.

4. The method as described in claim 1, wherein the success of the multiple sequences of the historic marketing sequence data is a continuation or cessation of a relationship.

5. The method as described in claim 1, wherein the desired communication channels are automated or digital.

6. The method as described in claim 1, wherein determining the sequence is further based on a desired demographic of persons for the desired multi-channel marketing campaign and demographics data of the historic marketing sequence data.

7. The method as described in claim 1, wherein determining the sequence for the desired category for the desired multi-channel marketing campaign determines a dynamic sequence, the dynamic sequence having one or more alternative options by which to adjust the communication channels based on an interaction or lack thereof by a user of the dynamic sequence during the desired multi-channel marketing campaign.

8. The method as described in claim 7, wherein determining the dynamic sequence aggregates multiple sequences sharing a common communication channel.

9. In a digital media environment for determining a best sequence of digital or mixed digital and non-digital communication channels for use in a digital or mixed multi-channel marketing campaign based on digital information concerning the digital and non-digital communication channels and success of multiple trial marketing sequences, the method comprising:
determining multiple trial marketing sequences, each of the trial marketing sequences having a same desired category and different communication channels or orders for communication channels;
performing, in a digital media environment, a trial multi-channel marketing campaign with the multiple trial marketing sequences, the performing including:
recording success for each of the trial marketing sequences; and
determining a best sequence based on the recorded success for each of the trial marketing sequences; or
determining a subset of the trial marketing sequences based on having a higher success relative to trial marketing sequences not of the subset;
performing a second trial multi-channel marketing campaign in the digital media environment with the subset of the multiple trial marketing sequences, the performing of the second trial including recording success for each of the subset of the trial marketing sequences; and
determining, based on the recorded success for each of the subset of the trial marketing sequences, a best sequence of the subset of the trial marketing sequences.

10. The method as described in claim 9, wherein determining the multiple trial marketing sequences is based on historic marketing sequence data for multiple historic sequences, the historic marketing sequence data indicating communication channels, order for the communication channels, categories, and successes.

11. The method as described in claim 9, wherein performing the trial multi-channel marketing campaign with the multiple trial marketing sequences is performed multiple times, each time with a different demographic of persons, and wherein determining the best sequence is specific to one of the different demographics.

12. The method as described in claim 9, wherein determining the best sequence based on the recorded success for each of the trial marketing sequences or based on the recorded success for each of the subset of the trial marketing sequences comprises determining a dynamic sequence, the dynamic sequence having one or more alternative options by which to adjust the communication channels based on an interaction or lack thereof by a user of the dynamic sequence.

13. The method as described in claim 12, wherein determining the dynamic sequence aggregates multiple sequences sharing a common communication channel.

14. In a digital media environment for determining a best sequence of digital or mixed digital and non-digital communication channels for use in a digital or mixed multi-channel marketing campaign based on digital information concerning the digital and non-digital communication channels and success of multiple trial marketing sequences, the method comprising:
receiving selection of a desired category for a desired multi-channel marketing campaign;
determining trial marketing sequences for the desired category based on a statistical measure of confidence for the trial marketing sequences, the statistical measure of confidence based on historic marketing sequence data for multiple sequences and the desired category, the trial marketing sequences having different communication channels or orders for communication channels;
performing, in a digital media environment, a trial multi-channel marketing campaign with the trial marketing sequences, the performing including recording success for each of the trial marketing sequences, the recording performed both digitally and without user interaction; and
determining, responsive to a statistically relevant quantity of successes being recorded for the trial marketing sequences during the trial multi-channel marketing campaign, a best sequence of the trial marketing sequences based on the statistically relevant quantity of recorded successes.

15. The method as described in claim 14, further comprising presenting, in a user interface and prior to receiving selection, multiple, selectable categories for the desired multi-channel marketing campaign and wherein receiving selection of the desired category is received through the user interface.

16. The method as described in claim 14, wherein determining the trial marketing sequences comprises correlating the desired category to a same category of sequences of the historic marketing data for multiple sequences.

17. The method as described in claim 14, wherein determining the trial marketing sequences comprises correlating the desired category to multiple similar categories of sequences of the historic marketing data for multiple sequences.

18. The method as described in claim 14, wherein the trial marketing sequences include four or more communication channels having different orders.

19. The method as described in claim 14, wherein the desired category indicates a type or class of product, relationship, interaction, or service.

20. The method as described in claim 14, wherein determining the best sequence determines, by aggregating multiple sequences sharing a common communication channel, a dynamic sequences having one or more alternative options by which to adjust the communication channels based on an interaction or lack thereof by a user of the dynamic sequence.
